(19) United States
(12) Patent Application Publication
(10) Pub. No.: US 2021/0156474 A1
(43) Pub. Date: May 27, 2021

(54) SYSTEM AND METHOD FOR REPLACEABLE SLEEVE CONFIGURATION

(71) Applicant: Baker Hughes Oilfield Operations LLC, Houston, TX (US)

(72) Inventors: Robert Bryan McHugh, Houston, TX (US); Jamie C. Gamble, Houston, TX (US)

(73) Assignee: Baker Hughes Oilfield Operations LLC, Houston, TX (US)

(21) Appl. No.: 16/695,491

(22) Filed: Nov. 26, 2019

(51) Int. Cl. F16J 15/3236; E21B 23/06

(52) U.S. Cl. CPC F16J 15/3236; F04B 53/143; E21B 23/06

(57) ABSTRACT

A system for controlling a wellbore pressure includes a body having a bore, a head coupled to the body, the head and body forming a chamber fluidly coupled to the bore, and a packer arranged in the chamber, the packer being moveable from a first position enabling flow through the floor and a second position blocking flow through the bore. The system also includes a piston positioned axially lower than the packer, the piston being moveable along an axis to drive the packer toward the second position from the first position, the piston having a removable sleeve including a sealing surface that engages at least a portion of a seal as the piston moves along the axis.

### BACKGROUND

### 1. Field of Invention

This disclosure relates in general to oil and gas tools, and in particular, to systems and methods for replacing components of wellhead tools, such as blowout preventers.

### 2. Description of the Prior Art

In oil and gas production, wellbore pressures may be regulated by different tools, which may be arranged within the wellbore or at a surface or subsea location. Blowout preventers (BOP) may be utilized to regulate flow through the wellbore and shut down flow, for example, in an overpressure flow scenario. Certain blowout preventers may include annular pistons that move axially along an axis of the wellbore. The movement of the piston may interface with a sealing element, such as a packer, to block a flow path out of the BOP. An outer diameter of the piston may include a sealing surface that interfaces with a chamber head during operation. Cycling of the piston may scar or otherwise damage the sealing surface, which may reduce the sealing integrity of the BOP. Typically, the sealing surface may be refmished by adding additional material, such as weld metal, and then machining the sealing surface. This process is inefficient, expensive, time consuming, and may also have limited repeatability.

### SUMMARY

Applicant recognized the problems noted above herein and conceived and developed embodiments of systems and methods, according to the present disclosure, for control of wellbore pressures.

In an embodiment, a system for controlling a wellbore pressure includes a body having a bore, a head coupled to the body, the head and body forming a chamber fluidly coupled to the bore, and a packer arranged in the chamber, the packer being moveable from a first position enabling flow through the floor and a second position blocking flow through the bore. The system also includes a piston positioned axially lower than the packer, the piston being moveable along an axis to drive the packer toward the second position from the first position, the piston having a removable sleeve including a sealing surface that engages at least a portion of a seal as the piston moves along the axis.

In an embodiment, a replaceable sleeve for a pressure control device includes a sealing surface extending along at least a portion of a body of the replaceable sleeve and a top portion axially above the sealing surface. The replaceable sleeve also includes a bottom portion axially lower than the sealing surface, the bottom portion having a radial thickness greater than a body thickness, the bottom portion adapted to engage a shoulder of a piston and to mechanically couple to the piston to block axial movement of the replaceable sleeve relative to the piston.

In an embodiment, a method to couple a replaceable sleeve to a piston includes coaxially aligning a replaceable sleeve with a piston. The method also includes arranging an inner diameter of the replaceable sleeve radially outward from an outer diameter of the piston. The method further includes securing a top portion of the replaceable sleeve to a top portion of the piston. The method also includes arranging a bottom portion of the replaceable sleeve along a shoulder of the piston. The method further includes securing the bottom portion of the replaceable sleeve to the piston.

### BRIEF DESCRIPTION OF THE DRAWINGS

The present technology will be better understood on reading the following detailed description of non-limiting embodiments thereof, and on examining the accompanying drawings, in which:

FIG. 1 is a schematic elevational view of an embodiment of a wellbore system, in accordance with embodiments of the present disclosure;

FIG. 2 is a schematic cross sectional view of an embodiment of a blowout preventer (BOP), in accordance with embodiments of the present disclosure;

FIG. 3 is a cross-sectional view of an embodiment of a sleeve, in accordance with embodiments of the present disclosure;

FIG. 4 is a cross-sectional view of an embodiment of a sleeve, in accordance with embodiments of the present disclosure;

FIG. 5 is a cross-sectional view of an embodiment of a sleeve, in accordance with embodiments of the present disclosure;

FIG. 6 is a cross-sectional view of an embodiment of a sleeve, in accordance with embodiments of the present disclosure;

FIG. 7 is a cross-sectional view of an embodiment of a sleeve, in accordance with embodiments of the present disclosure;

FIG. 8 is a cross-sectional view of an embodiment of a sleeve, in accordance with embodiments of the present disclosure; and

FIG. 9 is a flow chart of an embodiment of a method for installing a sleeve associated with a piston, in accordance with embodiments of the present disclosure.

### DETAILED DESCRIPTION OF THE INVENTION

The foregoing aspects, features and advantages of the present technology will be further appreciated when considered with reference to the following description of preferred embodiments and accompanying drawings, wherein like reference numerals represent like elements. In describing the preferred embodiments of the technology illustrated in the appended drawings, specific terminology will be used for the sake of clarity. The present technology, however, is not intended to be limited to the specific terms used, and it is to be understood that each specific term includes equivalents that operate in a similar manner to accomplish a similar purpose.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments,” or “other embodiments” of the present invention are not intended to be interpreted as excluding the existence of additional embodiments that also incorporate the recited features. Furthermore, reference to terms such as “above,” “below,” “upper”, “lower”, “side”, “front,” “back,” or other terms regarding orientation are made with reference to the illustrated embodiments and are not intended to be limiting or exclude other orientations.

Embodiments of the present disclosure include a replacement sleeve that may be coupled to an annular BOP piston, thereby replacing a sealing surface that may be damaged during normal operation. Replacement of the sleeve may reduce downtime and cost of ownership, thereby providing an advantage to operators. In various embodiments, the sleeve is removably coupled to the piston, such as via a mechanical fastener or the like, to facilitate installation and removal of the sleeve. In certain embodiments, the sleeve is coupled to the piston at more than one location, such as at a top and at a bottom, to block movement in multiple directions. In various embodiments, a sealing surface of the sleeve may include a coating or be formed from a different material to increase the useable life of the sealing surface.

In various embodiments, a replaceable sleeve is installed on an annular BOP piston to form an upper seal surface. When the seal surface of the sleeve is damaged, it may be replaced. Accordingly, the sleeve offers a repair solution for a piston that has reached its useful life, due either to past repairs that involved welding or damage that has been sustained to the seal surface. Utilizing the replaceable sleeve, rather than repeatedly repairing or replacing the piston may reduce the cost of ownership. In various embodiments, the sleeve includes a replaceable seal surface and may be secured to the piston via a mechanical fastener, or the like.

In embodiments, an equipment owner has the option to replace or repair the sleeve, as opposed to making modification or repairs to the piston itself. For example, scarring and corrosion damage may be seen on the seal surface, which may be referred to as the piston skirt. Over time, the seal surface may be damaged such that it is no longer serviceable, prompting a repair or replacement. Repairs of seal surfaces may include welding and re-machining the seal surface, which may be time consuming and costly. Embodiments of the present disclosure are directed toward replacement and/or repair of the sleeve. Replacement may eliminate a welding process from the procedure, which may reduce downtime while also lengthening the useful life for the component. In certain embodiments, the seal surface of the piston may be replaced without removing the piston from service.

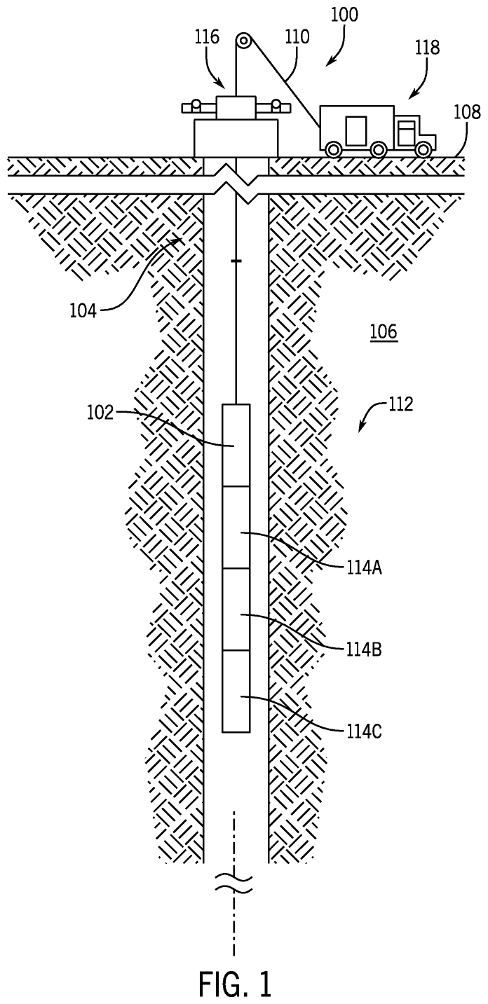

FIG. 1 is a schematic side view of an embodiment of a wellbore system 100 that includes a tool 102 (which may be part of a tool string) being lowered into a wellbore 104 formed in a formation 106 from a surface location 108. The illustrated wellbore 104 may be referred to as being open-bore, as no casing is illustrated along the wellbore walls. However, it should be appreciated that other wellbores, such as cased wellbores, may also utilize embodiments of the present disclosure. In a cased wellbore, casing may be installed along at least a portion of the wellbore walls and cemented in place, thereby forming a barrier along the wellbore walls. In embodiments the casing may be perforated to facilitate recovery of fluids, such as hydrocarbons, from the wellbore. Furthermore, it should be appreciated that other components may also be arranged within the wellbore 104 and the embodiment of FIG. 1 is for illustrative purposes only. For example, the wellbore 104 may also include plugs or remediation equipment. The illustrated wellbore system 100 may be referred to as a wireline system because the tool 102 is conveyed on a cable 110, such as an electric wireline although this system could also be deployed on a drill string for measurement while drilling. In various embodiments, the electric wireline may transmit electric signals and/or energy from the surface location 108 into the wellbore, for example to provide operational power for the tool 102 and/or to transmit data, such as data obtained from sensors arranged on the tool 102. In various embodiments, the tool 102 may be utilized to perform downhole logging operations, and may be an imaging tool, a resistivity tool, a nuclear tool, or any other logging tool that may be used in a downhole environment. Moreover, in various embodiments, the tool 102 may include multiple logging or imaging tools therein. For simplicity, all logging or imaging tools described herein will be described with reference to the tool 102. However, in various embodiments the logs or images obtained from the various tools may be obtained at different times using different tools 102.

As described above, in various embodiments the tool 102 may be part of a tool string 112, which may include various components utilized for wellbore operations. For example, the tool string 112 may include various other tools 114A-114C that may include sensors, measurement devices, communication devices, and the like, which will not all be described for clarity. In various embodiments, the tool string 112 may include one or more tools to enable at least one of a logging operation, a perforating operation, or a well intervention. For example, nuclear logging tools, fluid sampling tools, core sampling devices, and the like may be utilized in logging operations. Perforating operations may include ballistic devices being lowered into the wellbore to perforate casing or the formation. Furthermore, well interventions may include operations related to analyzing one or more features of the wellbore and proceeding with performing one or more tasks in response to those features, such as a data acquisition process, a cutting process, a cleaning process, a plugging process, and inspection process, and the like. Accordingly, in various embodiments, the tool string 112 may refer to tools that are lowered into the wellbore. Additionally, passive devices such as centralizers or stabilizers, tractors to facilitate movement of the tool string 112 and the like may also be incorporated into the tool string 112.

In various embodiments, different power and/or data conducting tools may be utilized by embodiments of the present disclosure in order to send and receive signals and/or electrical power. As will be described below, in various embodiments sensors may be incorporated into various components of the tool string 112 and may communicate with the surface or other tool string components, for example via communication through the cable 110, mud pulse telemetry, wireless communications, wired drill pipe, and the like. Furthermore, it should be appreciated that while various embodiments include a wireline system, in other embodiments rigid drill pipe, coiled tubing, or any other downhole exploration and production methods may be utilized with embodiments of the present disclosure.

The wellbore system 100 includes a wellhead assembly 116 shown at an opening of the wellbore 104 to provide pressure control of the wellbore and allow for passage of equipment into the wellbore 104, such as the cable 110 and the tool string 112. In various embodiments, the wellhead assembly 116 may include a blowout preventer (BOP), as will be described below. In this example, the cable 110 is a wireline being spooled from a service truck 118. The illustrated cable 110 extends down to the end of the tool string 112. In operation, the cable 110 may be provided with slack as the tool string 112 is lowered into the wellbore 104, for example to a predetermined depth. In various embodiments, a fluid may be delivered into the wellbore 104 to drive movement of the tool string 112, for example where gravity may not be sufficient, such as in a deviated wellbore. For example, a fluid pumping system (not illustrated) at the surface may pump a fluid from a source into the wellbore 104 via a supply line or conduit. To control the rate of travel of the downhole assembly, tension on the wireline 110 is controlled at a winch on the surface, which may be part of the service tuck 118. Thus, the combination of the fluid flow rate and the tension on the wireline may contribute to the travel rate or rate of penetration of the tool string 112 into the wellbore 104. The cable 110 may be an armored cable that includes conductors for supplying electrical energy (power) to downhole devices and communication links for providing two-way communication between the downhole tool and surface devices. Moreover, in various embodiments, tools such as tractors and the like may further be disposed along the tool string 112 to facilitate movement of the tool string 112 into the wellbore 104. Thereafter, in various embodiments, the tool string 112 may be retrieved from the wellbore 14 by reeling the cable 110 upwards via the service truck 118. In this manner, logging operations may be performed as the tool string 112 is brought to the surface 108.

In operation, the wellhead assembly 116 may be utilized to control pressure within the wellbore 104, for example, to block or otherwise prevent undesirable flow out of the wellbore 104. The wellhead assembly 116 may include a BOP that includes a mechanism that blocks a bore extending through the wellhead assembly 116. The BOP may be referred to as an annular BOP where the sealing mechanism is arranged within a chamber formed in the BOP. However, it should be appreciated that, in various embodiments, there may be multiple BOPs and different types may be used, such as ram BOPs and the like. Blocking the bore may restrict or block flow. In various embodiments, the BOP may include a piston assembly that drives a sealing member, such as an elastomer or a metallic seal, into the bore to block flow. The piston assembly may include a piston that interfaces with a chamber head. The interaction between the piston and the chamber head may damage or otherwise scar the sealing surface of the piston, which may reduce the sealing capabilities of the piston. As noted above, repairs or replacement may be expensive and time consuming. Accordingly, embodiments of the present disclosure may be utilized to quickly replace the sealing surface of the piston by using a removable sleeve that may be coupled to the piston. The piston may include an outer diameter that acts as the sealing surface and, when damaged, may be replaced or repaired.

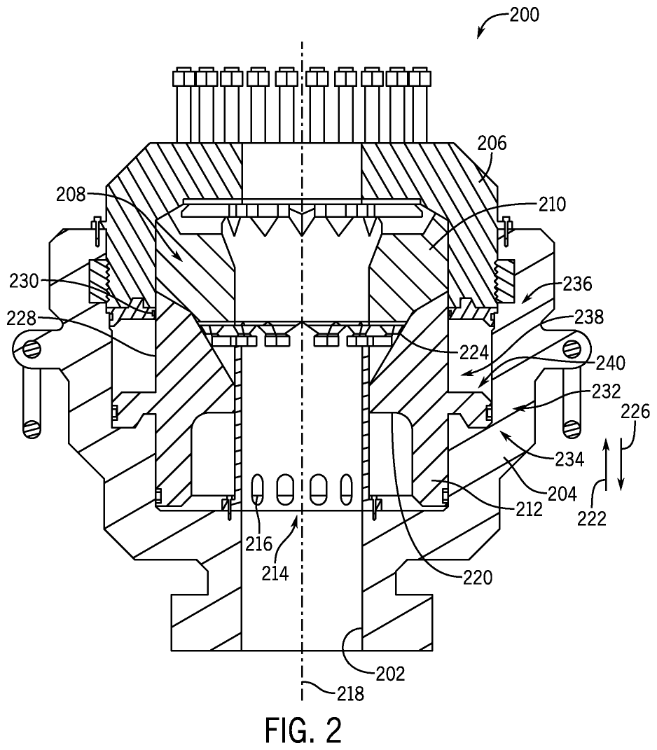

FIG. 2 is a schematic cross-sectional view of an embodiment of a BOP 200. As noted above, the BOP 200 may be used to regulate or otherwise control flow through a wellbore, for example, to regulate flow through a bore 202 extending through the BOP 200. The illustrated BOP 200 includes a body 204 and a head 206. The head 206 is coupled to the body 204, forming a chamber 208 that houses a packer 210 and a piston 212. The chamber 208 also includes a flow control device 214, which includes slots 216 to direct fluid toward the piston 212.

The illustrated piston 212 is arranged within the chamber 208 and moves axially along a BOP axis 218 in response to a fluid pressure acting on a flange 220 of the piston 212. The fluid pressure drives the piston 212 in an upward direction 222, which drives an interface 224 against the packer 210. In various embodiments, the packer 210 may be an elastomer or metallic packer 210, or a combination of the two, and may deform or otherwise move radially inwardly and block the bore 202. In embodiments where the BOP 200 is reusable, when the pressure is removed or reduced from the flange 220, the piston 212 may move in the downward direction 226.

As the piston 212 reciprocates within the chamber 208, a sealing surface 228 may engage or contact a chamber seal 230 and/or at least a portion of the head 206. Movement of the sealing surface 228 in response to fluid pressure may damage the sealing surface 228, which may reduce the sealing integrity of the BOP 200. For example, the fluid may contain particulates or the like, which may damage the sealing surface 228. Additionally, in embodiments, vibrations or other forces may impact the sealing surface 228. As noted above, when the sealing surface 228 is damaged, the BOP 200 may be taken out of service while the sealing surface 228 is repaired, such as by adding additional material and re-machining the surface. This process may be expensive and/or time consuming. Accordingly, embodiments of the present disclosure may be utilized to simplify repairs to the sealing surface 228 by utilizing a sleeve that may be arranged coaxially with the piston 212 to contact the chamber seal 230 and/or the head 206.

As described above, the piston 220 may reciprocate within the chamber 208 to move between an open chamber position and a closed chamber position. The embodiment illustrated in FIG. 2 is an open chamber position, where a piston extension 232 is positioned at a lower portion 234 of the body 204. It should be appreciated that the open chamber position is not limited to situations where the piston extension 232 is seated at the lower portion 234 of the body 204, and in various embodiments, the open chamber position may include intermediate positions where flow is still enabled through the bore 202. It should be appreciated that, in certain embodiments, a fluid pressure may be applied to the piston extension 232, the piston 212, or another component in order to drive the piston 220 toward the open chamber position.

Additionally, embodiments may include the closed chamber position where the piston is driven in the upward direction 222 such that the piston extension 232 engages, at least in part with an upper portion 236 of the body 204 and/or the chamber seal 230. For example, as will be described below, in various embodiments the sealing surface 228 may include an axial sealing portion 238 and a radial sealing portion 240. Accordingly, both an upper sealing surface (substantially the axial sealing portion 238) and a lower sealing surface (substantially the radial sealing portion 240) may be utilized to provide control flow through the bore 202.

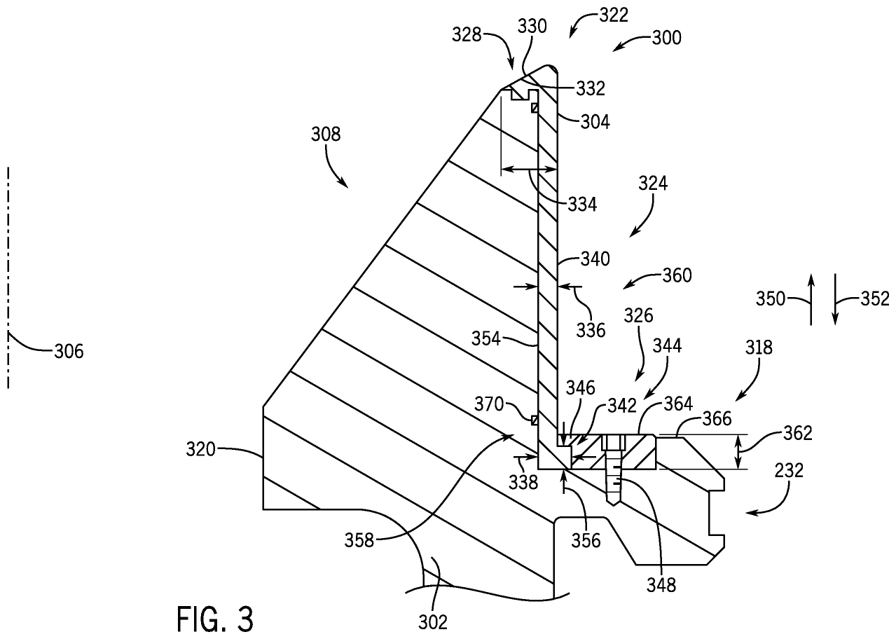

FIG. 3 is a cross-sectional view of an embodiment of a piston assembly 300 including a piston 302 and a replaceable sleeve 304 (e.g., sleeve, piston sleeve) arranged circumferentially about the piston 302. It should be appreciated that the piston 302 and the replaceable sleeve 304 may be annular components that extend about an axis 306. The piston assembly 300 may be utilized with a BOP, such as the BOP 200 illustrated in FIG. 2.

The piston 302 includes an interface 308, which interacts with the packer (not shown) as the piston 302 is driven along the axis 306. The illustrated interface 308 includes a slanted or sloped surface in the illustrated embodiment. It should be appreciated that while the illustrated interface 308 includes a single sloped surface with a substantially constant slope, in other embodiments, different sloped surfaces may be included along the interface 308. That is, a lower portion of the interface 308 may have a different slope than an upper portion of the interface 210. The piston 302 also includes a shoulder 318 arranged radially outward from the axis 306. As will be described below, the shoulder 318 may receive the sleeve 304 and, in various embodiments, may be utilized to secure the sleeve 304 to the piston 302. In the illustrated embodiment, the shoulder 318 may share one or more components with the previously described piston extension 232. For example, the shoulder 318 may form at least a portion of the radial sealing portion 240.

The sleeve 304 is arranged radially outward from a bore 320 and circumferentially about the piston 302. In various embodiments, the sleeve 304 is not a continuous piece, but rather, is a sectional component comprised of multiple pieces. However, in other embodiments, the sleeve 304 is a continuous piece. The sleeve 304 includes a top portion 322, a body portion 324, and a bottom portion 326. The top portion 322, in the illustrated embodiment, engages a recess 328 formed in the piston 302 to secure, at least in part, the sleeve 304 to the piston 302. The top portion 322 includes an arm 330 positioned at least partially within the recess 328. As a result, radial movement of the sleeve 304 may be restricted. The top portion 322 further includes a slanted section 332, which may substantially conform to the interface 308 or have a different slope, as shown in FIG. 3.

The illustrated sleeve 304 includes a first thickness 334 (e.g., radial thickness) at the top portion, a second thickness 336 at the body portion 324, and a third thickness 338 at the bottom portion 326. As noted above, the first thickness 334 may be used, at least in part, to secure the sleeve 304 to the piston 302, and as a result, may be larger than the second thickness 336. The second thickness 336 may be particularly selected based on the chamber of the BOP to facilitate sealing engagement between the chamber seal and/or the head. In embodiments, the body portion 324 includes at least a portion of a sealing surface 340, which engages the chamber seal and/or the head. In various embodiments, the sealing surface 340 may include a coating or the like to facilitate sealing and/or improve longevity. Furthermore, in embodiments, the sealing surface 340 and/or the sleeve 304 may be formed from a harder material than the piston 302 to provide a longer lifespan for the component. In certain embodiments, the sealing surface 340 along the body portion 324 may correspond to the axial sealing portion 238.

The illustrated bottom portion 326 includes the third thickness 338, which is greater than the second thickness 336. The third thickness 338 in the illustrated embodiment forms at least a portion of a shelf 342, which may be utilized to secure the sleeve 304 to the piston 302 via a retainer 344. The illustrated retainer 344 includes a lip 346 that engages the shelf 342 when the retainer 344 is arranged along the shoulder 318. In certain embodiments, the retainer 344 is a continuous piece that extends circumferentially about the axis 306. In other embodiments, the retainer 344 may be a split piece that is installed in segments. Furthermore, in embodiments, the retainer 344 may not be arranged fully circumferentially about the sleeve 304. For example, segments may be arranged at different circumferential locations to secure the sleeve 304 to the piston 302. In various embodiments, a fastener 348 couples the retainer 344 to the piston 302. Due to the overlapping lip 346, axial movement of the sleeve 304 is restricted in a first direction 350 and axial movement is restricted in a second direction 352 at least due to the top portion 322 and the shoulder 318. In this manner, the sleeve 304 may be secured to the piston 302.

In the illustrated embodiment, the sleeve 304 is arranged in contact with an outer diameter portion 354 of the piston 302. Seals 356 are positioned within seal grooves 358 formed in the piston 302. In various embodiments, the seals 356 are elastomeric or metallic seals that may compress when the sleeve 304 is arranged about the piston 302. The seals 356 may block ingress of fluids or particulates between the piston 302 and the sleeve 304. Accordingly, embodiments of the present disclosure may include the sleeve 304 positioned radially outward from the outer diameter portion 354 of the piston 302 and also positioned coaxially with the piston 302. The sleeve 304 may be removable, for example, when the sealing surface 340 is damaged. Thereafter, the sleeve 304 may be replaced or repaired. In various embodiments, the sleeve 304 may be removed without disassembling other components of the BOP, such as removal of the piston 302, to simplify repairs and reduce the time to make repairs.

In various embodiments, as noted above, the sleeve 304 is mechanically coupled to the piston 302, for example, via the fastener 348. Advantageously, the mechanical coupling may simplify removal of the sleeve 304. For example, if the sleeve 304 were welded or the like to the piston 302, the entire piston 302 would be removed for replacement of repair of the sleeve 304.

In various embodiments, features of the piston assembly 300 may be adjusted to accommodate various dimensions or the like of the BOP. For example, an outer diameter 360 of the sealing surface 340 (e.g., the axial portion of the sealing surface) may be particularly selected based on the head and/or chamber seals of the BOP. Furthermore, in embodiments, a stroke length of the piston 302 may impact a stop height 362, illustrated as the distance between the shoulder 318 and a top 364 of the retainer 344. In the illustrated embodiment, the top 364 is at a greater vertical location than a top 366 of the piston extension 232. As a result, at least a portion of the top 364 may be utilized to form portions of the radial sealing portion 240. Advantageously, the retainer 344 may also be replaced if damage occurs along the top 364. In certain embodiments, the stop height 362 may be a factor of a bottom portion height 370, to provide sufficient overlap between the lip 346 and the shelf 342. It should be appreciated that the position of these components may be adjusted. For example, the stop height 362 may be reduced such that the top 364 is substantially flush with the top 366. Or the top 366 may be at a greater vertical position than the top 364. As a result, the top 366 may also form at least a portion of the radial sealing portion 240. Accordingly, various components may be adjusted to account for expected operating conditions, manufacturing simplicity, and the like.

It should be appreciated that while embodiments illustrate the sleeve positioned along the axial sealing portion 238 and the radial sealing portion 240, it should be appreciated that the sleeve may be expanded to the piston extension 232, such that the sleeve wraps around the piston extension 232. Moreover, the sleeve may also be arranged on the opposite side from that illustrated in FIG. 3. The sleeve may be coupled in a similar manner, and therefore, so clarity only sleeves arranged on the upper portion will be described herein, although such description is not intended to be limiting.

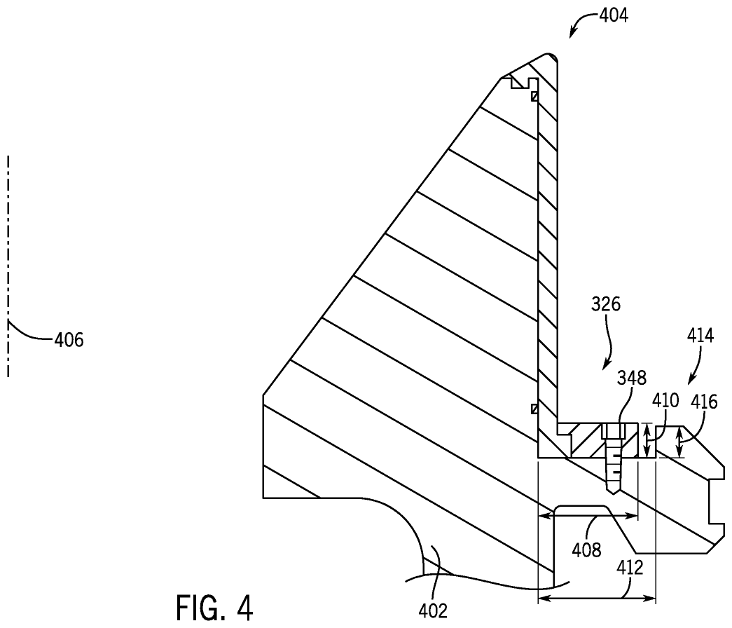

FIG. 4 is a cross-sectional view of an embodiment of a piston assembly 400 including a piston 402 and a replaceable sleeve 404 (e.g., sleeve, piston sleeve) arranged circumferentially about the piston 402. As noted above, the piston 402 and the replaceable sleeve 404 may be annular components that extend about an axis 406. The piston assembly 400 may be utilized with a BOP, such as the BOP 200 illustrated in FIG. 2. The piston assembly 400 shares several features of the piston assembly 300 described in FIG. 3, such as the top portion, body portion, and the like. As a result, for simplicity, these similar features will not be described with respect to FIG. 4. The embodiment of FIG. 4 differs from that of FIG. 3 by removing the retainer 344 and directly coupling the bottom portion 326 to the shoulder 318. For example, in the illustrated embodiment, the bottom portion 326 includes a radial length 408 and an axial height 410. The radial length 408 may extend less than a shoulder length 412 to substantially fill a recessed area 414 of the shoulder 318, but still leave a gap or space. However, it should be appreciated that the radial length 408 may be substantially equal to the shoulder length 412 to substantially filly the recessed area 414 without a gap or space. The axial height 410 may be substantially equal to a recessed area height 416 to enable a substantially flush arrangement between the bottom portion 326 and the top 366. However, as noted above, the bottom portion 326 may be higher than or shorter than the top 366, based on design conditions and the like. In various embodiments, the bottom portion 326 is secured to the piston 402, for example, via the fastener 348. Accordingly, the sleeve 404 may be secured to the piston utilizing fewer parts than the embodiment illustrated in FIG. 3.

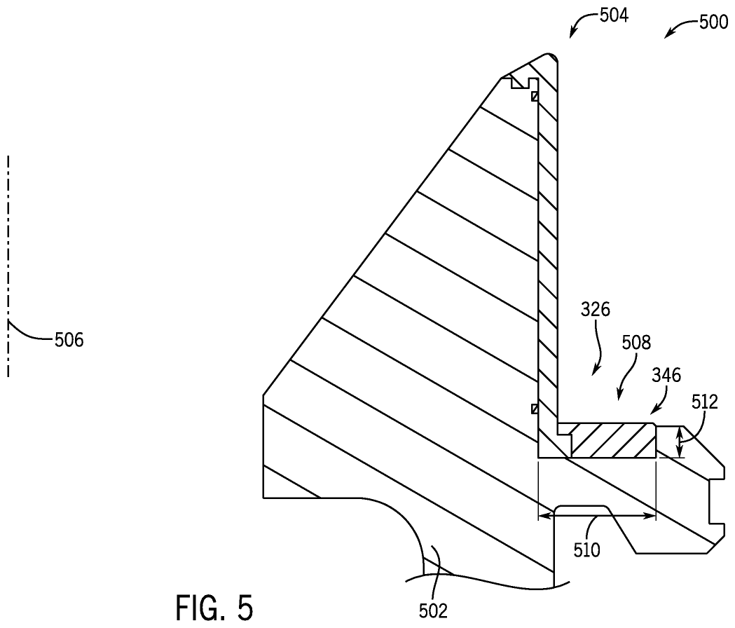

FIG. 5 is a cross-sectional view of an embodiment of a piston assembly 500 including a piston 502 and a replaceable sleeve 504 (e.g., sleeve, piston sleeve) arranged circumferentially about the piston 502. As noted above, the piston 502 and the replaceable sleeve 504 may be annular components that extend about an axis 506. The piston assembly 500 may be utilized with a BOP, such as the BOP 200 illustrated in FIG. 2. The piston assembly 500 shares several features of the piston assembly 300 described in FIG. 3, such as the top portion, body portion, and the like. As a result, for simplicity, these similar features will not be described with respect to FIG. 5. The embodiment of FIG. 5 differs from that of FIG. 3, in part, by removing the fastener 348 and press fitting the retainer 364 into the shoulder 318. For example, in embodiments, the shoulder 318 may include a recessed area 508 having a radial length 510 and axial height 512. The combination of the bottom portion 326 and the retainer 344 may be substantially equal to the radial length 510 and/or larger than the radial length 510. As a result, the retainer 344 may be press fit into the recessed area 508 to secure the sleeve 504 to the piston 502.

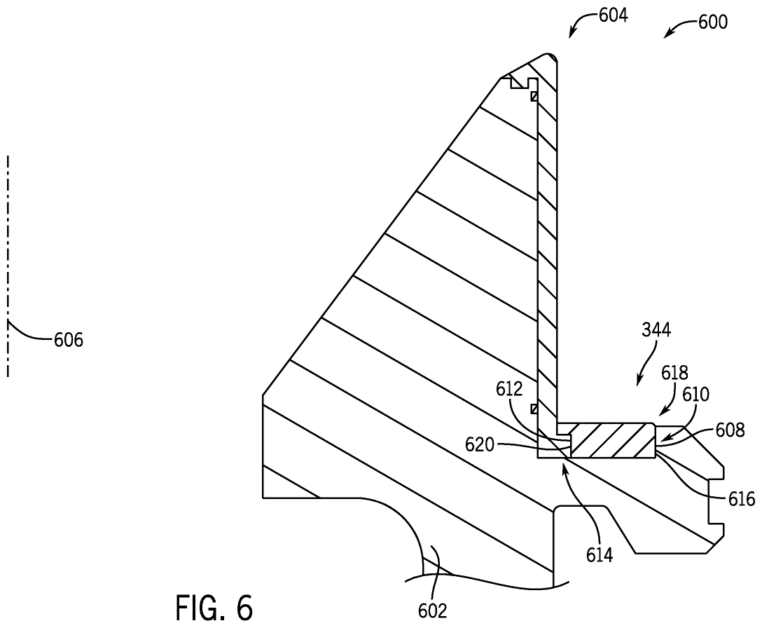

FIG. 6 is a cross-sectional view of an embodiment of a piston assembly 600 including a piston 602 and a replaceable sleeve 604 (e.g., sleeve, piston sleeve) arranged circumferentially about the piston 602. As noted above, the piston 602 and the replaceable sleeve 604 may be annular components that extend about an axis 606. The piston assembly 600 may be utilized with a BOP, such as the BOP 200 illustrated in FIG. 2. The piston assembly 600 shares several features of the piston assembly 300 described in FIG. 3, such as the top portion, body portion, and the like. As a result, for simplicity, these similar features will not be described with respect to FIG. 6. The embodiment of FIG. 6 further includes the retainer 344 described above. However, in place of the fastener 348, the retainer 344 is coupled to the sleeve 604 and the piston 602 via mating threads. For example, in the illustrated embodiment, the retainer 344 includes first threads 608 along an outer diameter 610 and second threads 612 along an inner diameter 614. The first threads 608 engage piston threads 616 arranged within a recessed area 618 and the second threads 612 engage sleeve threads 620. In the illustrated embodiment, the sleeve threads 620 are along the bottom portion 326. Accordingly, the retainer 344 may be mechanically coupled to both the piston 602 and the sleeve 604, preventing axial movement of the sleeve 604 relative to the piston 602. It should be appreciated that both sets of threads 608, 612 may not be included, with their accompanying mating threads, and a single set of threads of may be utilized to secure the retainer 344 into position. For example, in various embodiments, the retainer may include the first threads 608 that mate with the piston threads 616 without including the threads along the sleeve 604.

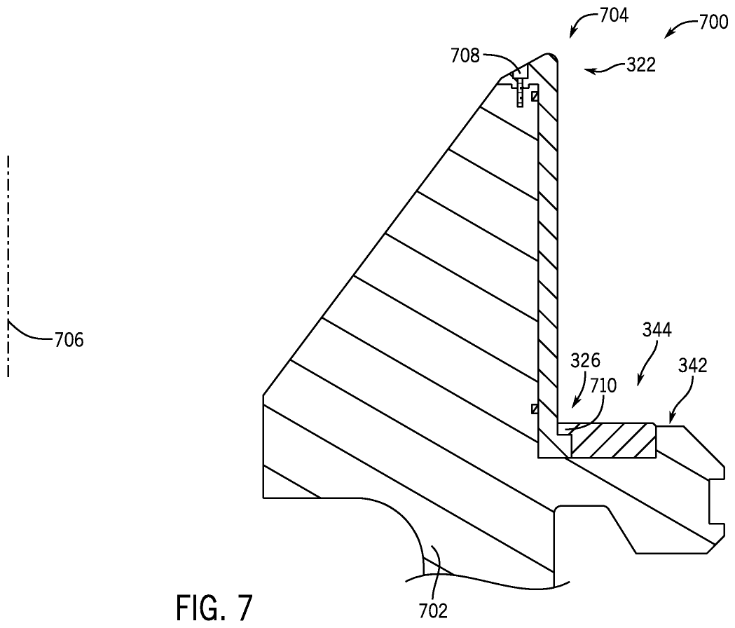

FIG. 7 is a cross-sectional view of an embodiment of a piston assembly 700 including a piston 702 and a replaceable sleeve 704 (e.g., sleeve, piston sleeve) arranged circumferentially about the piston 702. As noted above, the piston 702 and the replaceable sleeve 704 may be annular components that extend about an axis 706. The piston assembly 700 may be utilized with a BOP, such as the BOP 200 illustrated in FIG. 2. The piston assembly 700 shares several features of the piston assembly 300 described in FIG. 3, such as the top portion, body portion, and the like. As a result, for simplicity, these similar features will not be described with respect to FIG. 7. The embodiment of FIG. 7 includes the top portion 322 of the sleeve 704 secured to the piston 702 via a fastener 708. The illustrated embodiment includes the retainer 344 arranged along the shelf 342 and further includes a seal 710 positioned between the bottom portion 326 and the retainer 344. In various embodiments, the seal 710 may be utilized to facilitate sealing along the radial sealing portion 240. As described above, movement of the seal 704 in an axial direction is blocked due to the fastener 708 and movement in the radial direction is also blocked via the fastener 708 and the retainer 344. It should be appreciated that the embodiment of FIG. 7, or portions thereof, may also be incorporated into other embodiment described herein. For example, the fastener 708 may also be included in other embodiments, such as FIG. 3, to include two different mechanical fasteners to secure the sleeve 704 to the piston 702.

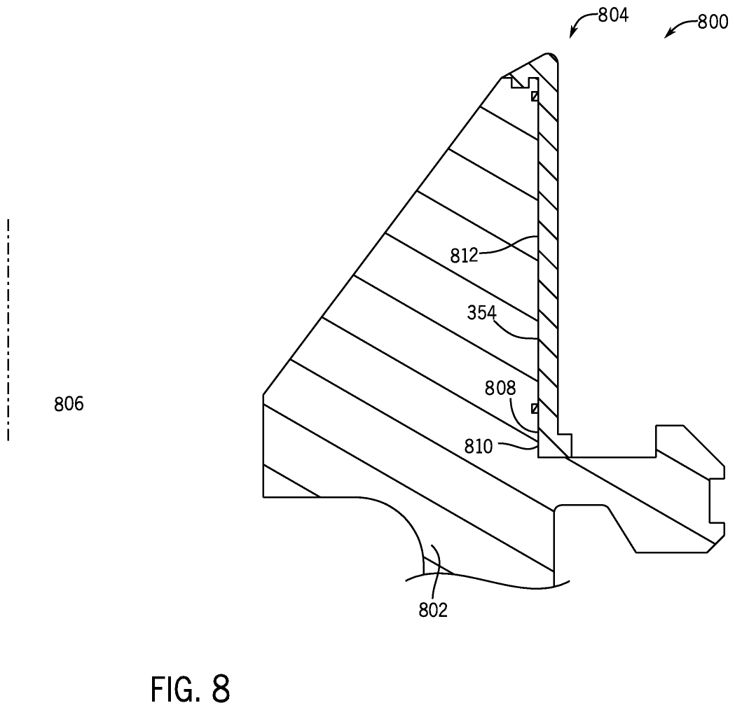

FIG. 8 is a cross-sectional view of an embodiment of a piston assembly 800 including a piston 802 and a replaceable sleeve 804 (e.g., sleeve, piston sleeve) arranged circumferentially about the piston 802. As noted above, the piston 802 and the replaceable sleeve 804 may be annular components that extend about an axis 806. The piston assembly 800 may be utilized with a BOP, such as the BOP 200 illustrated in FIG. 2. The piston assembly 800 shares several features of the piston assembly 300 described in FIG. 3, such as the top portion, body portion, and the like. As a result, for simplicity, these similar features will not be described with respect to FIG. 8. The embodiment of FIG. 8 does not include the retainer 344 described above. Instead, threads 808, 810 are arranged along the piston 802 and the sleeve 804. For example, the threads 808 are positioned along the outer diameter portion 354 to mate with the threads 810 positioned along an inner diameter portion 812 of the sleeve. It should be appreciated that the threads 808, 810 may extend along the entire respective lengths, over a portion of the respective lengths, or any combination thereof.

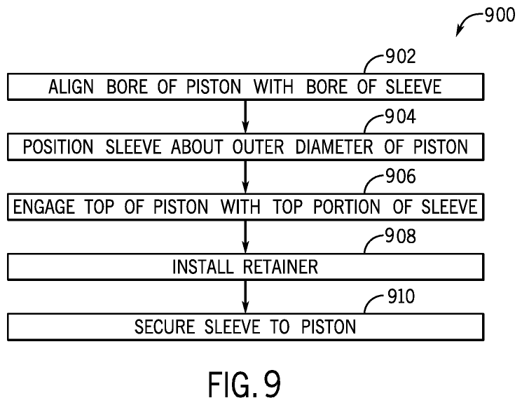

FIG. 9 is a method 900 for installing a sleeve to a piston. It should be appreciated that the steps of the method may be performed in any order, or in parallel, unless otherwise specifically stated. Furthermore, in embodiments, there may be more or fewer steps. The method 900 of FIG. 9 begins with aligning a bore of a piston with a bore of a sleeve 902. For example, each of the piston and the sleeve may be formed from annular components that may be positioned coaxial to one another once installed. The sleeve is arranged along an outer diameter of the piston 904. In other words, the sleeve may be positioned to circumferentially surround at least a portion of the piston. In various embodiments, a top portion of the sleeve may engage a top of the piston 906. For example, as noted above, the top portion of the sleeve may include an arm that engages a recess formed in the piston. In embodiments, a retainer may be installed 908. The retainer may be arranged circumferentially about the sleeve and may be utilized to secure the sleeve into place. As noted above, in various embodiments, the retainer is positioned within a recessed area. The sleeve is then secured to the piston 910. In embodiments, a fastener may be utilized to couple the retainer to the piston, which may secure the sleeve to the piston. However, in various other embodiments, the retainer may be threaded into the piston, press fit into the piston, or the like.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A system for controlling a wellbore pressure, comprising:
a body having a bore;
a head coupled to the body, the head and body forming a chamber fluidly coupled to the bore;
a packer arranged in the chamber, the packer being moveable from a first position enabling flow through the floor and a second position blocking flow through the bore; and
a piston positioned axially lower than the packer, the piston being moveable along an axis to drive the packer toward the second position from the first position, the piston having a removable sleeve including a sealing surface that engages at least a portion of a seal as the piston moves along the axis.

2. The system of claim 1, further comprising:
a head seal arranged between the head and the body, the head sealing including the portion of the seal.

3. The system of claim 1, wherein the removable sleeve comprises:
a top portion;
a body portion; and
a bottom portion;
wherein the sleeve is arranged coaxially with the piston to position the sealing surface radially outward from an outer diameter of the piston.

4. The system of claim 3, wherein the top portion further comprises:
an arm extending radially inward from the sealing surface, the arm engaging a recess formed in the piston.

5. The system of claim 3, wherein the bottom portion is arranged within a recess formed on a shoulder of the piston, the bottom portion extending a radial length along the shoulder and being mechanically coupled to the piston.

6. The system of claim 5, wherein bottom portion is mechanically coupled to the piston via at least one of a fastener or a press fit.

7. The system of claim 5, further comprising:
a retainer arranged within the recess, the retainer having a lip that overlaps at least a portion of the bottom portion.

8. The system of claim 5, further comprising:
first threads arranged along an outer diameter of the piston; and
second threads arranged along an inner diameter of the sleeve;
wherein the first threads couple to the second threads to secure the sleeve to the piston.

9. The system of claim 1, further comprising:
a piston seal arranged within a piston groove, the piston seal being radially between an outer diameter of the piston and an inner diameter of the sleeve.

10. A replaceable sleeve for a pressure control device, comprising:
a sealing surface extending along at least a portion of a body of the replaceable sleeve;
a top portion axially above the sealing surface; and
a bottom portion axially lower than the sealing surface, the bottom portion having a radial thickness greater than a body thickness, the bottom portion adapted to engage a shoulder of a piston and to mechanically couple to the piston to block axial movement of the replaceable sleeve relative to the piston.

11. The replaceable sleeve of claim 10, further comprising:
a shelf formed along at least a portion of the radial thickness, the shelf adapted to receive a lip of a retainer, the retainer comprising an aperture for receiving a fastener to mechanically couple the replaceable sleeve to the piston.

12. The replaceable sleeve of claim 10, further comprising:
an arm extending radially inward from the sealing surface, the arm adapted to couple to a top portion of the piston, the arm engaging a recess formed in the piston.

13. The replaceable sleeve of claim 12, wherein a first sloped surface of the arm substantially corresponds to a second sloped surface of an interface of the piston.

14. The replaceable sleeve of claim 10, wherein the radial thickness is substantially equal to a shoulder length, the radial thickness adapted to receive a fastener to mechanically couple the replaceable sleeve to the piston.

15. The replaceable sleeve of claim 10, wherein the bottom portion comprises sleeve threads, the sleeve threads adapted to engage mating retainer threads along an inner diameter of a retainer, the retainer securing the replaceable sleeve to the piston.

16. The replaceable sleeve of claim 10, wherein the sealing surface includes at least one of a coating or a hard facing treatment.

17. A method to couple a replaceable sleeve to a piston, comprising:
coaxially aligning a replaceable sleeve with a piston;
arranging an inner diameter of the replaceable sleeve radially outward from an outer diameter of the piston;
securing a top portion of the replaceable sleeve to a top portion of the piston;
arranging a bottom portion of the replaceable sleeve along a shoulder of the piston; and
securing the bottom portion of the replaceable sleeve to the piston.

18. The method of claim 17, wherein securing the top portion of the replaceable sleeve to the top portion of the piston further comprises:
engaging a recess formed in the piston with an arm of the replaceable sleeve, the arm extending radially inward from a sealing surface of the replaceable sleeve.

19. The method of claim 17, further comprising:
positioning a retainer along the shoulder, at least a portion of the retainer overlapping at least a portion of the bottom portion; and
securing the retainer to the piston.

20. The method of claim 17, wherein the bottom portion is mechanically coupled to the piston.
